(19) United States
(12) Patent Application Publication
(10) Pub. No.: US 2025/0284324 A1
(43) Pub. Date: Sep. 11, 2025

(54) ELECTRONIC APPARATUS AND HINGE DEVICE

(71) Applicant: Lenovo (Singapore) Pte. Ltd., Singapore (SG)

(72) Inventors: Shigehiro Horiuchi, Kanagawa (JP); Takehito Yamauchi, Kanagawa (JP)

(73) Assignee: Lenovo (Singapore) Pte. Ltd., Singapore (SG)

(21) Appl. No.: 19/074,680

(22) Filed: Mar. 10, 2025

(30) Foreign Application Priority Data
Mar. 11, 2024 (JP) 2024-037314

(51) Int. Cl. G06F 1/16; F16C 11/04

(52) U.S. Cl. CPC G06F 1/1681; F16C 11/04

(57) ABSTRACT

An electronic apparatus includes a first chassis, a second chassis, and a hinge device that connects the first chassis and the second chassis. The hinge device includes a first shaft fixed relative to the first chassis, a second shaft fixed relative to the second chassis, a support member configured to support the first shaft and the second shaft so as to be rotatable relative to each other with axial directions parallel to each other, a first slider having a first end portion facing a first shaft side and a second end portion facing a second shaft side and configured to be slidable between the first shaft and the second shaft, and a second slider having a first end portion facing the first shaft side and a second end portion facing the second shaft side and configured to be slidable between the first shaft and the second shaft.

### BACKGROUND OF THE INVENTION

### Cross-Reference to Related Applications

This application claims priority to Japanese Patent Application No. 2024-037314 filed on Mar. 11, 2024, the contents of which are hereby incorporated herein by reference in their entirety.

### FIELD OF THE INVENTION

The present invention relates to an electronic apparatus including a hinge device that connects two chassis to be rotatable, and the hinge device.

### DESCRIPTION OF THE RELATED ART

For example, Japanese Patent No. 5976052 discloses an electronic apparatus of a convertible type PC in which a second chassis having a display is connected to a first chassis having a keyboard to be rotatable in an angle range of 0 degrees to 360 degrees. In this configuration, a hinge device having a biaxial structure with two rotation shafts corresponding to each chassis is used.

### SUMMARY OF THE INVENTION

In the hinge device of Japanese Patent No. 5976052, cam members having recessed portions are fixed to each of the two rotation shafts, and one floating pin is selectively fitted into each of the recessed portions. Accordingly, the hinge device is able to selectively rotate each of the rotation shafts according to an angle range between the chassis. Specifically, only the rotation shaft on the second chassis side having the display rotates from 0 degrees to 180 degrees, and only the rotation shaft on the first chassis side having the keyboard rotates from 180 degrees to 360 degrees. As a result, the shafts smoothly rotate within the angle between chassis from 0 degrees to 360 degrees.

As described above, the configuration of Japanese Patent No. 5976052 switches which of the two rotation shafts is rotated at a position of 180 degrees. Therefore, in this configuration, for example, when the angle between the chassis is set to about 120 degrees and the electronic apparatus is used as a laptop PC, a lower edge portion of the second chassis is positioned above the first chassis. Therefore, in this configuration, the lower bezel of the display provided in the second chassis is large and exposed to the exterior, and the appearance quality of the entire apparatus is deteriorated.

In order to solve this problem, it is also considered to reverse the rotation timing of each shaft. Specifically, it is also considered that only the rotation shaft on the first chassis side having the keyboard is rotated from 0 degrees to 180 degrees, and only the rotation shaft on the second chassis side having the display is rotated from 180 degrees to 360 degrees. However, in this case, the lower edge portion of the second chassis is disposed below the first chassis at an angle greater than 90 degrees, for example, at about 120 degrees for use as a laptop PC. As a result, in this case, the lower edge portion of the second chassis comes into contact with a desk surface or the like, causing problems of rattling and damage. In addition, when the lower edge portion of the second chassis comes into contact with a desk surface or the like, the first chassis having the keyboard will lift up, and the two chassis will not be disposed flat when viewed from the side at a position of 180 degrees.

Embodiments of the present disclosure provide an electronic apparatus and a hinge device that improves the appearance quality and suppress rattling and damage to the chassis during use.

An electronic apparatus according to a first aspect of the present invention includes a first chassis having a first surface and a second surface, a second chassis having a first surface and a second surface and adjacent to the first chassis, and a hinge device configured to connect the first chassis and the second chassis to be rotatable from a first folded form in which first surfaces of the first chassis and the second chassis face each other to a second folded form in which second surfaces of the first chassis and the second chassis face each other, by connecting edge portions of the first chassis and the second chassis adjacent to each other to be rotatable relative to each other, in which the hinge device includes a first shaft fixed relative to the first chassis, a second shaft fixed relative to the second chassis, a support member configured to support the first shaft and the second shaft so as to be rotatable relative to each other with axial directions parallel to each other, a first slider having a first end portion facing a first shaft side and a second end portion facing a second shaft side, and configured to be slidable between the first shaft and the second shaft, a second slider having a first end portion facing the first shaft side and a second end portion facing the second shaft side and configured to be slidable between the first shaft and the second shaft, a first cam member fixed to the first shaft and having an outer peripheral surface provided with a locking part to which the first end portion of the second slider is fittable, and a second cam member fixed to the second shaft and having an outer peripheral surface provided with a first recessed portion into which the second end portion of the first slider is fittable and a second recessed portion into which the second end portion of the second slider is fittable.

A hinge device according to a second aspect of the present invention is a hinge device that connects a first chassis and a second chassis of an electronic apparatus to be rotatable, the hinge device including a first shaft fixed relative to the first chassis, a second shaft fixed relative to the second chassis, a support member configured to support the first shaft and the second shaft so as to be rotatable relative to each other with axial directions parallel to each other, a first slider having a first end portion facing a first shaft side and a second end portion facing a second shaft side, and configured to be slidable between the first shaft and the second shaft, a second slider having a first end portion facing the first shaft side and a second end portion facing the second shaft side and configured to be slidable between the first shaft and the second shaft, a first cam member fixed to the first shaft and having an outer peripheral surface provided with a locking part to which the first end portion of the second slider is fittable, and a second cam member fixed to the second shaft and having an outer peripheral surface provided with a first recessed portion into which the second end portion of the first slider is fittable and a second recessed portion into which the second end portion of the second slider is fittable.

According to the above-described aspect of the present invention, it is possible to improve the appearance quality and to suppress rattling and damage to the chassis during use.

### BRIEF DESCRIPTION OF THE DRAWINGS

FIG. 1 is a schematic plan view of an electronic apparatus according to one or more embodiments as viewed from above.

FIG. 2 is a schematic side view of a hinge device and a peripheral portion thereof when a first chassis and a second chassis are in a first folded form.

FIG. 3 is a view in which the first chassis and the second chassis illustrated in FIG. 2 are at a first angular position.

FIG. 4 is a view in which the first chassis and the second chassis illustrated in FIG. 3 are at a position of 120 degrees.

FIG. 5 is a view in which the first chassis and the second chassis illustrated in FIG. 4 are at a position of 180 degrees.

FIG. 6 is a view in which the first chassis and the second chassis illustrated in FIG. 5 are at a second angular position.

FIG. 7 is a view in which the first chassis and the second chassis illustrated in FIG. 6 are in a second folded form.

FIG. 8 is a perspective view of the hinge device.

FIG. 9 is a front view of the hinge device.

FIGS. 10A-10C are side cross-sectional views of the hinge device in the first folded form, in which FIG. 10A illustrates a cross section taken along the line A-A in FIG. 9, FIG. 10B illustrates a cross section taken along the line B-B in FIG. 9, and FIG. 10C illustrates a cross section taken along the line C-C in FIG. 9.

FIGS. 11A-11C are side cross-sectional views of the hinge device at a position of 60 degrees, in which FIG. 11A illustrates a cross section taken along the line A-A in FIG. 9, FIG. 11B illustrates a cross section taken along the line B-B in FIG. 9, and FIG. 11C illustrates a cross section taken along the line C-C in FIG. 9.

FIGS. 12A-12C are side cross-sectional views of the hinge device at the first angular position, in which FIG. 12A illustrates a cross section taken along the line A-A in FIG. 9, FIG. 12B illustrates a cross section taken along the line B-B in FIG. 9, and FIG. 12C illustrates a cross section taken along the line C-C in FIG. 9.

FIGS. 13A-13C are side cross-sectional views of the hinge device at a position of 120 degrees, in which FIG. 13A illustrates a cross section taken along the line A-A in FIG. 9, FIG. 13B illustrates a cross section taken along the line B-B in FIG. 9, and FIG. 13C illustrates a cross section taken along the line C-C in FIG. 9.

FIGS. 14A-14C are side cross-sectional views of the hinge device at a position of 180 degrees, in which FIG. 14A illustrates a cross section taken along the line A-A in FIG. 9, FIG. 14B illustrates a cross section taken along the line B-B in FIG. 9, and FIG. 14C illustrates a cross section taken along the line C-C in FIG. 9.

FIGS. 15A-15C are side cross-sectional views of the hinge device at the second angular position, in which FIG. 15A illustrates a cross section taken along the line A-A in FIG. 9, FIG. 15B illustrates a cross section taken along the line B-B in FIG. 9, and FIG. 15C illustrates a cross section taken along the line C-C in FIG. 9.

FIGS. 16A-16C are side cross-sectional views of the hinge device at a position of 300 degrees, in which FIG. 16A illustrates a cross section taken along the line A-A in FIG. 9, FIG. 16B illustrates a cross section taken along the line B-B in FIG. 9, and FIG. 16C illustrates a cross section taken along the line C-C in FIG. 9.

FIGS. 17A-17C are side cross-sectional views of the hinge device at a position of 360 degrees, in which FIG. 17A illustrates a cross section taken along the line A-A in FIG. 9, FIG. 17B illustrates a cross section taken along the line B-B in FIG. 9, and FIG. 17C illustrates a cross section taken along the line C-C in FIG. 9.

### DETAILED DESCRIPTION OF THE INVENTION

Embodiments of an electronic apparatus and a hinge device according to the present invention will be described in detail below with reference to the accompanying drawings.

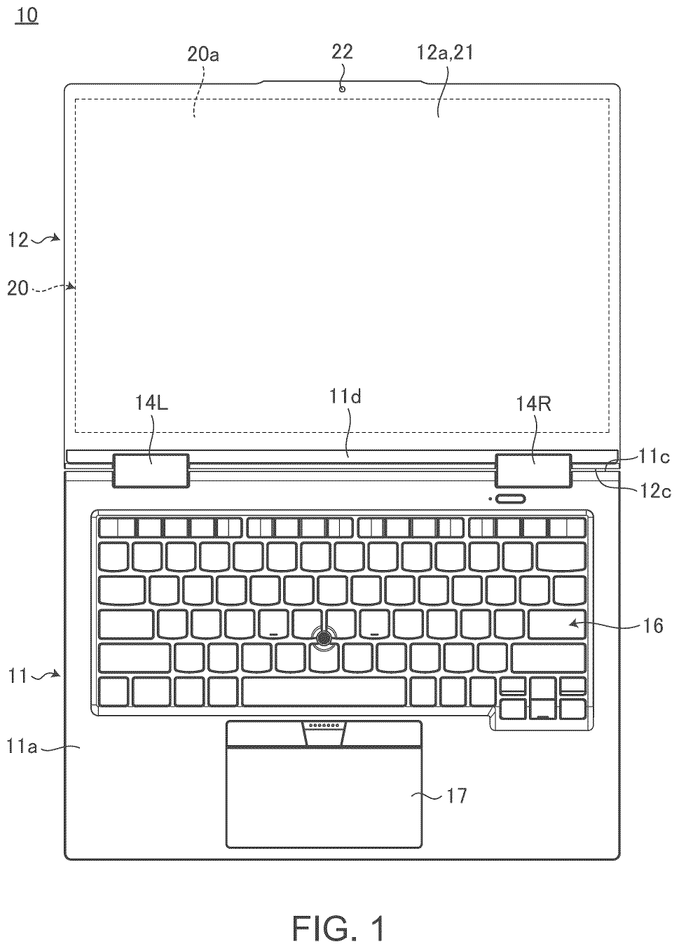

FIG. 1 is a schematic plan view of an electronic apparatus 10 according to one or more embodiments as viewed from above. The electronic apparatus 10 has a configuration in which a first chassis 11 and a second chassis 12 are connected by left and right hinge devices 14L and 14R so as to be rotatable relative to each other. Hereinafter, the hinge devices 14L and 14R may be collectively referred to as a “hinge device 14”.

The electronic apparatus 10 is a so-called convertible type PC that can be used as a laptop PC (laptop mode) or a tablet type PC (tablet mode) depending on an angular position between the chassis 11 and 12. The laptop mode is a state in which the second chassis 12 is rotated with respect to the first chassis 11 at, for example, an angular position of about 120 degrees. The tablet mode is a state in which the second chassis 12 is rotated with respect to the first chassis 11 at, for example, an angular position of 360 degrees. The electronic apparatus 10 may be a mobile phone, a smartphone, an electronic notebook, a game machine, or the like.

The hinge device 14 can be moved down with an edge portion 11c of the hinge device 14 side of the second chassis 12 protruding backward during an opening operation. Accordingly, the laptop mode is a so-called drop-down structure in which a part or all of a lower bezel 11d of a display 20 is hidden behind the first chassis 11 (see FIGS. 3 and 4).

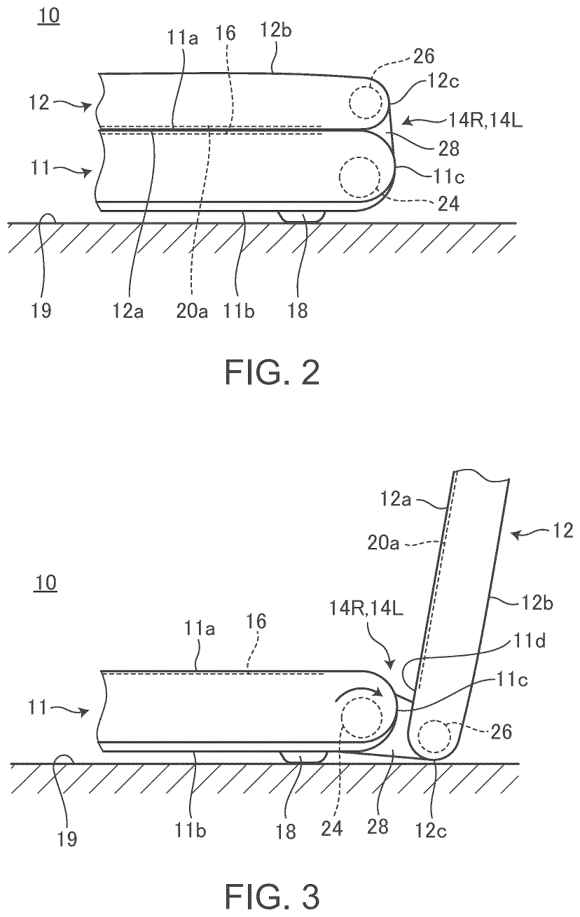

FIGS. 2 to 7 are schematic side views of the hinge device 14 and the peripheral portion thereof at each angular position when the second chassis 12 of the electronic apparatus 10 illustrated in FIG. 1 is rotated from 0 degrees to 360 degrees with respect to the first chassis 11.

Hereinafter, a direction viewed from an operator who uses the electronic apparatus 10 in a laptop mode as illustrated in FIG. 4 will be referred to as a reference, and a depth direction will be referred to as front and rear, a width direction will be referred to as left and right, and a thickness direction will be referred to as up and down.

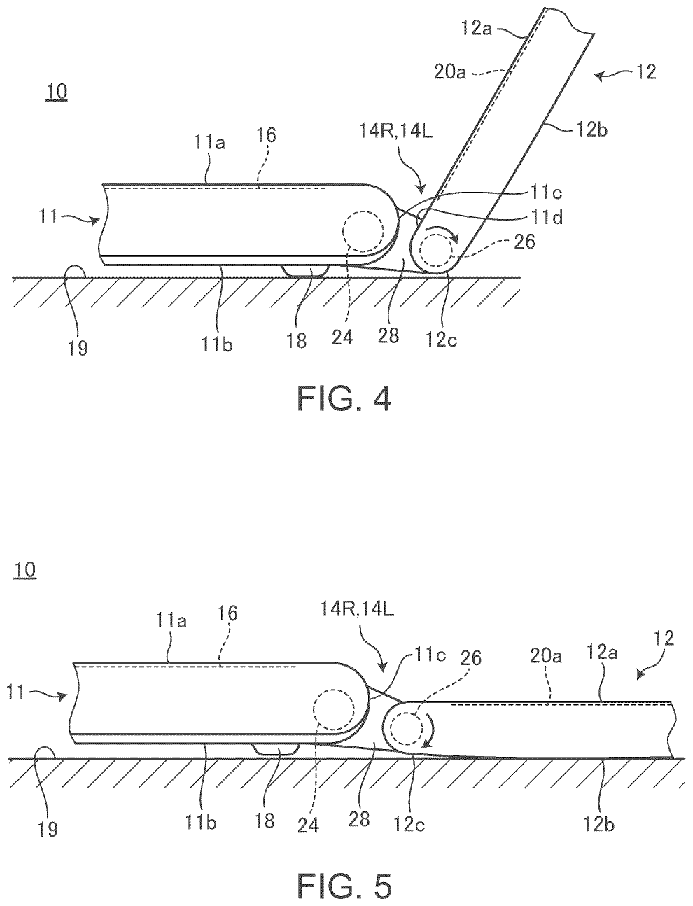

For convenience of description, the angular position of the first chassis 11 and the second chassis 12 is referred to as a 0-degree position (see FIG. 2), in which the second chassis 12 is closed with respect to the first chassis 11 and a front surface (first surface) 12a of the second chassis 12 faces an upper surface (first surface) 11a of the first chassis 11. The following description is based on the 0-degree position, with the angle ticking in the direction of opening while rotating the second chassis 12. For example, a posture in which the second chassis 12 and the first chassis 11 are substantially orthogonal to each other is referred to as a 90-degree position. A posture in which the front surface 12a of the second chassis 12 and the upper surface 11a of the first chassis 11 face the same direction (upward) and are parallel to each other is referred to as a 180-degree position (see FIG. 5). A posture in which a rear surface (second surface) 12b of the second chassis 12 and a bottom surface (second surface) 11b of the first chassis 11 face each other is referred to as a 360-degree position (see FIG. 7). The 0-degree position, 90-degree position, 120-degree position, 180-degree position, 360-degree position, and the like can naturally deviate slightly from the exact angular positions indicated by the angle numbers, depending on the structure of the chassis 11, 12, or the hinge device 14. For convenience, these deviated angular positions will be referred to as a 0-degree position or the like.

As illustrated in FIGS. 1 to 7, in the electronic apparatus 10, the edge portion (one edge portion) 11c on a rear side of the first chassis 11 and an edge portion (one edge portion) 12c on a lower side of the second chassis 12 are adjacent to each other. The edge portions 11c and 12c are connected so as to be rotatable relative to each other by a pair of left and right hinge devices 14L and 14R.

The first chassis 11 is a flat box having a rectangular outer shape in a plan view. Inside the first chassis 11, various electronic components such as a motherboard on which a CPU and the like are mounted, a battery device, a memory, an antenna device, and the like are accommodated. A keyboard 16 and a touch pad 17 face the upper surface 11a of the first chassis 11. The reference numeral 18 in FIG. 2 denotes a rubber foot that serves as a leg portion when the bottom surface 11b is placed on a placement surface 19 such as a desk surface.

The second chassis 12 has a rectangular outer shape in a plan view and is a flat box that is thinner than the first chassis 11. A display surface 20a of the display 20 faces the front surface 12a of the second chassis 12. The display 20 can be configured with a liquid crystal display or an organic EL display. The display surface 20a is able to display a video or an image. The front surface 12a of the second chassis 12 is covered with a glass plate 21 on substantially the entire surface thereof including the display surface 20a of the display 20. The glass plate 21 can be configured with touch glass corresponding to a touch operation. The reference numeral 22 in FIG. 1 denotes a camera.

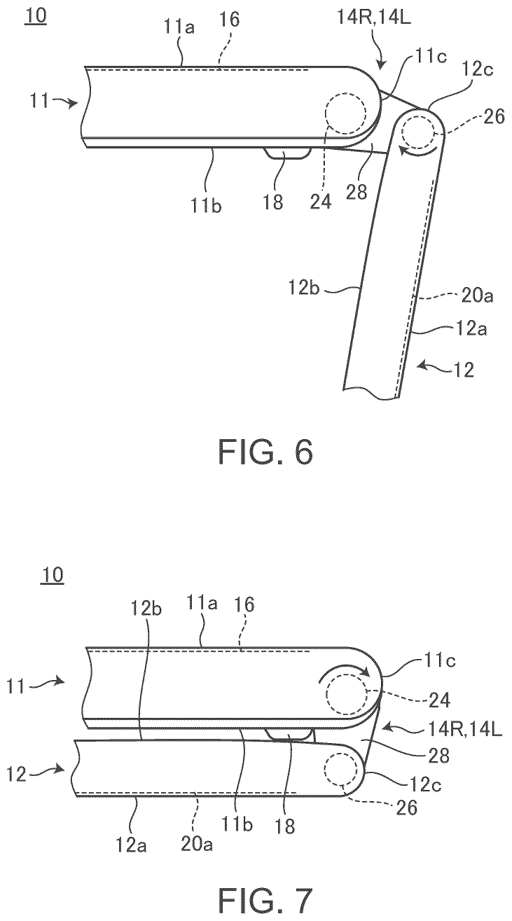

As illustrated in FIGS. 2 to 7, the hinge device 14 is able to rotate the chassis 11 and 12 from a 0-degree position (first folded form) to a 360-degree position (second folded form) by a biaxial structure. FIG. 2 illustrates a 0-degree position, FIG. 3 illustrates a 100-degree position, FIG. 4 illustrates a 120-degree position, FIG. 5 illustrates a 180-degree position, FIG. 6 illustrates a 280-degree position, and FIG. 7 illustrates a 360-degree position.

The hinge devices 14L and 14R include a first shaft 24, a second shaft 26, and a hinge chassis 28. The first shaft 24 is relatively fixed to the first chassis 11. The second shaft 26 is relatively fixed to the second chassis 12. That is, the first shaft 24 rotates integrally with the first chassis 11. The second shaft 26 rotates integrally with the second chassis 12. The hinge chassis 28 supports the shafts 24 and 26 so as to be rotatable relative to each other. The hinge chassis 28 can also have a bar shape that is long and extends over the left and right hinge devices 14L and 14R.

The hinge chassis 28 is disposed substantially along the up-down direction at a 0-degree position (see FIG. 2) and a 360-degree position (see FIG. 7). At the 0-degree position, the second shaft 26 is disposed above the first shaft 24. At the 360-degree position, the second shaft 26 is disposed below the first shaft 24. Accordingly, in the electronic apparatus 10, the front-rear direction positions of the edge portions 11c and 12c of the chassis 11 and 12 substantially coincide with each other at the 0-degree position and the 360-degree position. At the 0-degree position and the 360-degree position, the front-rear direction positions of the other edge portions (front edge portions) of the chassis 11 and 12 opposite to the edge portions 11c and 12c also substantially coincide with each other.

The hinge device 14 includes a rotation shaft selection mechanism portion 30 that selects one of the first shaft 24 and the second shaft 26 and rotates only the selected shaft. In the hinge device 14, rotation of the first shaft 24 is allowed and rotation of the second shaft 26 is stopped between the 0-degree position and the 100-degree position (first angular position) (see FIGS. 2 and 3). In the hinge device 14, the rotation of the second shaft 26 is allowed and the rotation of the first shaft 24 is stopped between the 100-degree position and the 280-degree position (second angular position) (see FIGS. 3 to 6). In the hinge device 14, the rotation of the first shaft 24 is allowed and the rotation of the second shaft 26 is stopped between the 280-degree position and the 360-degree position (see FIGS. 6 and 7). As described above, in the hinge device 14, the first shaft 24 or the second shaft 26 is selected at two switching angular positions (for example, the 100-degree position and the 280-degree position). Accordingly, in the hinge device 14, only one selected shaft rotates as a rotation shaft between the chassis 11 and 12, and the rotation of the other shaft is locked.

Next, a specific configuration example of the hinge device 14 will be described.

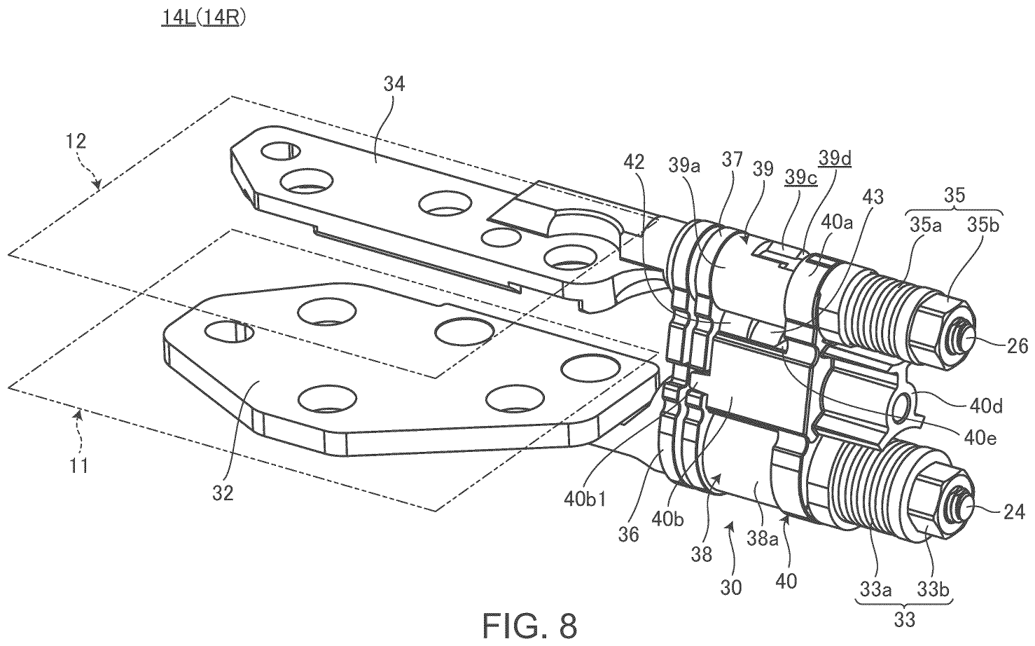

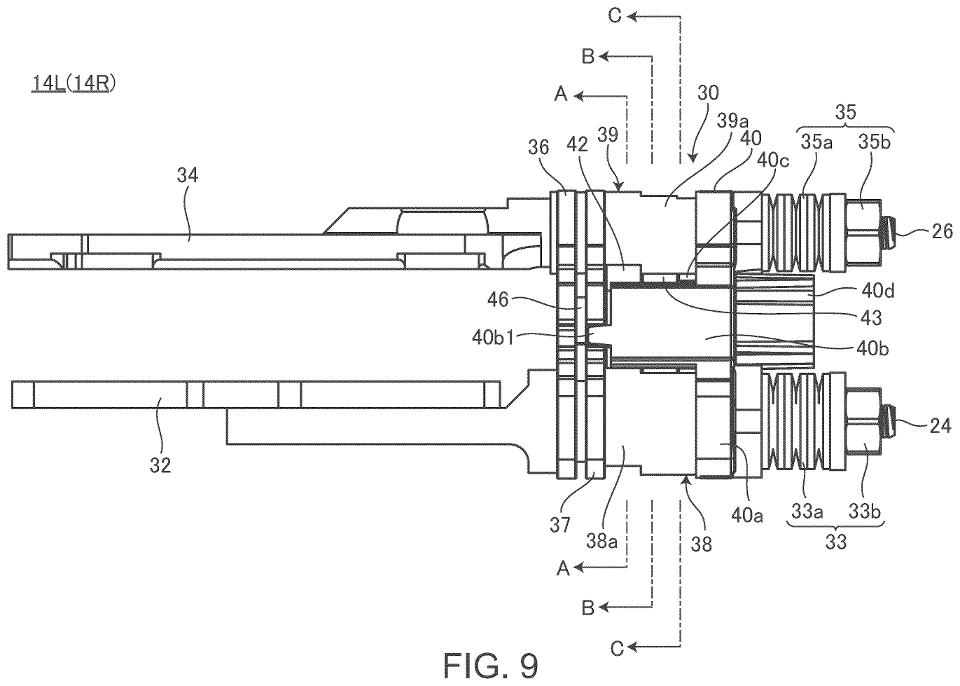

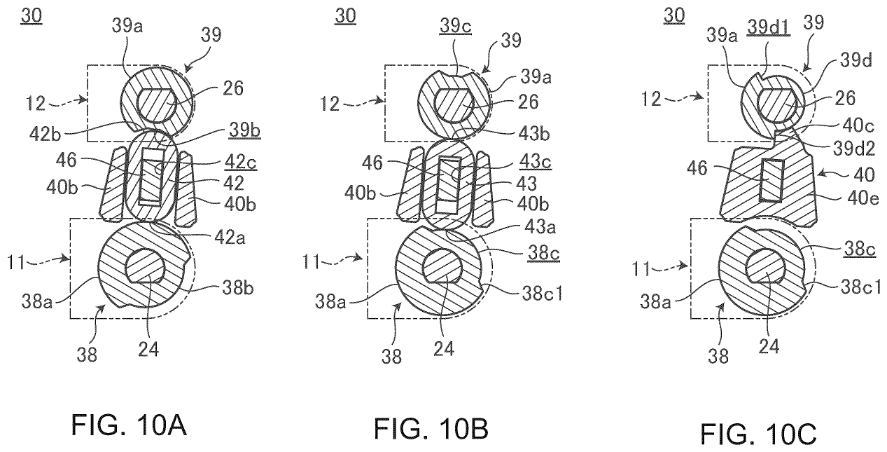

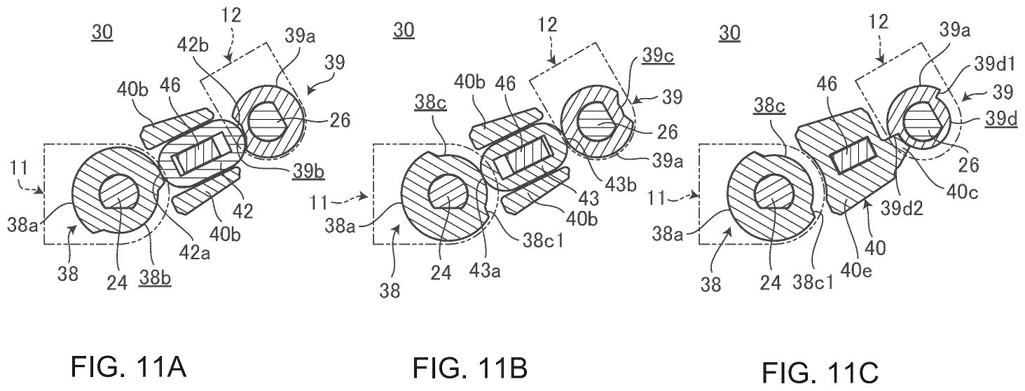

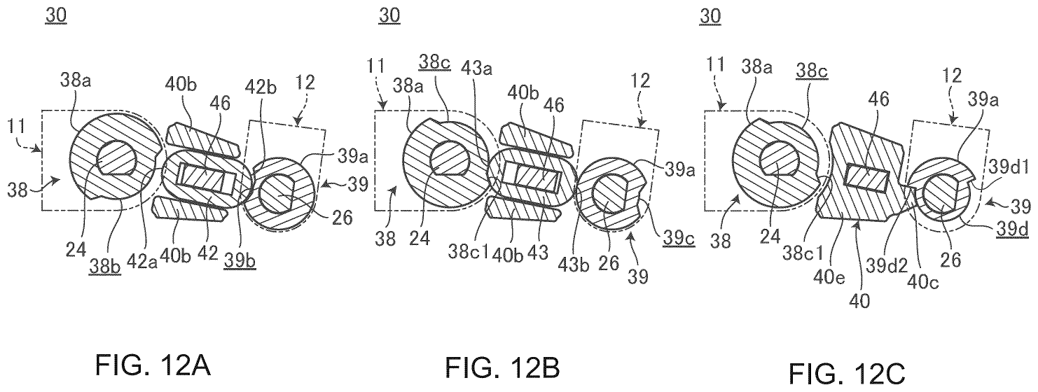

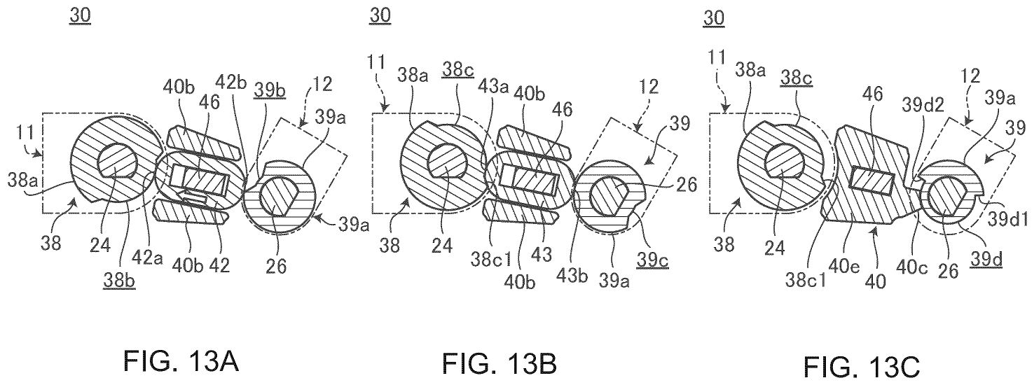

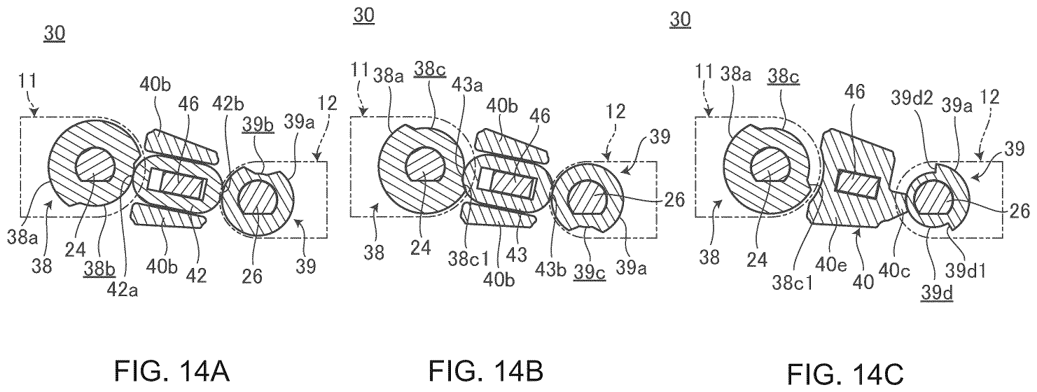

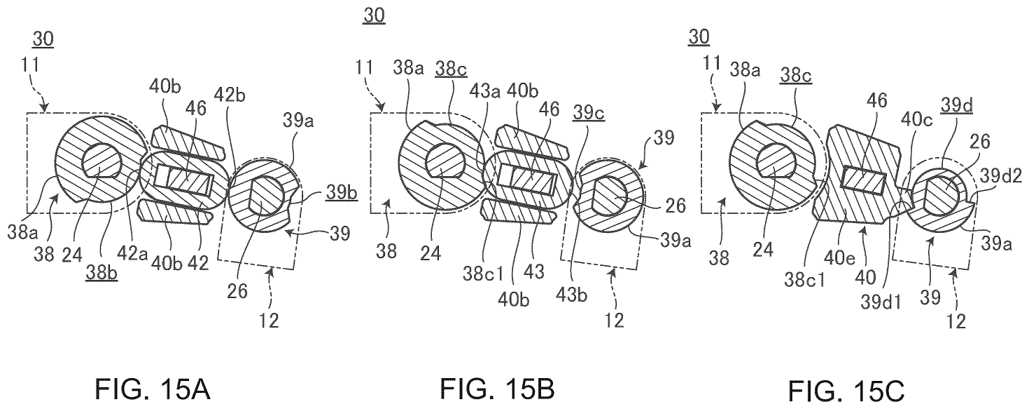

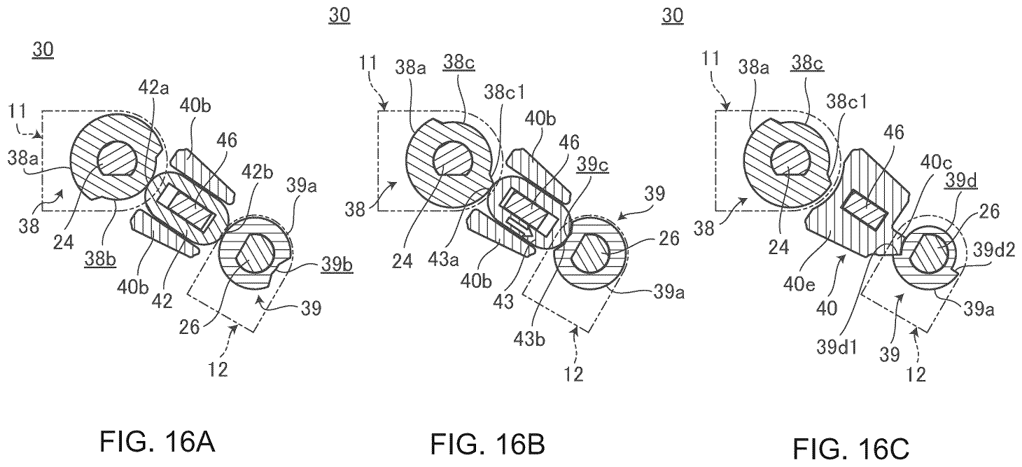

FIG. 8 is a perspective view of the hinge device 14L. FIG. 9 is a front view of the hinge device 14L. FIGS. 8 and 9 are views illustrating the internal structure of the hinge device 14L with the hinge chassis 28 detached. FIGS. 10A, 10B, and 10C are side cross-sectional views of the hinge device 14L at the 0-degree position. Similarly, FIGS. 11A, 11B, and 11C illustrate a 60-degree position, FIGS. 12A, 12B, and 12C illustrate a 100-degree position, FIGS. 13A, 13B, and 13C illustrate a 120-degree position, FIGS. 14A, 14B, and 14C illustrate a 180-degree position, FIGS. 15A, 15B, and 15C illustrate a 280-degree position, FIGS. 16A, 16B, and 16C illustrate a 300-degree position, and FIGS. 16A, 16B, and 16C illustrate a 360-degree position. In FIG. 10, FIG. 10A illustrates a cross section taken along the line A-A in FIG. 9, FIG. 10B illustrates a cross section taken along the line B-B in FIG. 9, and FIG. 10C illustrates a cross section taken along the line C-C in FIG. 9. Similarly, FIGS. 11A, 11B, 11C, and the like in FIGS. 11A to 17C illustrate cross sections taken along the lines A-A, B-B, and C-C in FIG. 9, respectively, and illustrate a state in which the hinge device 14L is operated from FIGS. 10A, 10B, and 10C.

In one or more embodiments, the right hinge device 14R can have the same or similar configuration as the left hinge device 14L except that the right hinge device 14R has a left-right symmetrical structure with respect to the left hinge device 14L. Therefore, hereinafter, the left hinge device 14L will be typically described, and specific description and illustration of the right hinge device 14R will be omitted.

As illustrated in FIGS. 8 to 10, the hinge device 14L includes the first shaft 24 and the second shaft 26 whose axial directions are parallel to each other, the hinge chassis 28 (see FIG. 2) that supports each of the shafts 24 and 26 so as to be rotatable relative to each other, and the rotation shaft selection mechanism portion 30 that selectively switches between rotation timings of each of the shafts 24 and 26.

The first shaft 24 and the second shaft 26 are cylindrical shafts. The axial directions of the respective shafts 24 and 26 are disposed in the directions along the longitudinal direction (the left-right direction) of the edge portions 11c and 12c. On the outer peripheral surfaces of the respective shafts 24 and 26, cut surfaces for preventing rotation of the members (cam members 38 and 39 and the like) to be externally fitted and fixed are formed at appropriate positions.

A first bracket 32 is connected to one end (left end) of the first shaft 24 such that the first bracket 32 and the first shaft 24 are not rotatable relative to each other. The first bracket 32 is a metal plate for fixing the first shaft 24 to the first chassis 11 so that the first shaft 24 is not rotatable. The first bracket 32 is screwed to the inner surface of the first chassis 11. A first torque generation unit 33 is attached to the other end (right end) of the first shaft 24. The first torque generation unit 33 has a configuration in which, for example, a plurality of dish-shaped leaf springs 33a are laminated in a row in the axial direction of the first shaft 24 and are pressed by nuts 33b. The first torque generation unit 33 is able to apply a predetermined rotational torque to the rotation of the first shaft 24.

A second bracket 34 is connected to one end (left end) of the second shaft 26 such that the second bracket 34 and the second shaft 26 are not rotatable relative to each other. The second bracket 34 is a metal plate for fixing the second shaft 26 to the second chassis 12 so that the second shaft 26 is not rotatable. The second bracket 34 is screwed to the inner surface of the second chassis 12. A second torque generation unit 35 is attached to the other end (right end) of the second shaft 26. The second torque generation unit 35 has a configuration in which, for example, a plurality of dish-shaped leaf springs 35a are laminated in a row in the axial direction of the second shaft 26 and are pressed by a nut 35b. The second torque generation unit 35 is able to apply a predetermined rotational torque to the rotation of the second shaft 26.

As illustrated in FIGS. 8 to 10, the rotation shaft selection mechanism portion 30 can include support plates 36 and 37, a first cam member 38, and a stopper cam member 40 in order from one end side to the other end side of the first shaft 24. Hereinafter, the rotation shaft selection mechanism portion 30 may be simply referred to as a “mechanism portion 30”. The mechanism portion 30 can include the support plates 36 and 37, a second cam member 39, and the stopper cam member 40 in order from one end side to the other end side of the second shaft 26. The mechanism portion 30 can include the support plates 36 and 37, a first slider 42, a second slider 43, and the stopper cam member 40 in order from one end side to the other end side in a space between the first shaft 24 and the second shaft 26 (inter-shaft space).

The hinge chassis 28 is provided to cover each constituent element of the shafts 24 and 26 and the mechanism portion 30. The hinge chassis 28 can be rotated around the shaft of the first shaft 24 or the second shaft 26 selected by the mechanism portion 30 (see FIGS. 2 to 7). During the rotation, the hinge chassis 28 is integrally rotated with the support plates 36 and 37, the stopper cam member 40, and the like.

The support plates 36 and 37 are substantially flat elliptical metal plates that are bridged over the first shaft 24 and the second shaft 26. The support plates 36 and 37 have shaft holes into which the respective shafts 24 and 26 are inserted so as to be rotatable relative to each other at both end portions. Accordingly, the support plates 36 and 37 function as a support member that support each of the shafts 24 and 26 so as to be rotatable relative to each other while maintaining the inter-shaft distance between the shafts 24 and 26. In the configuration example illustrated in FIGS. 8 and 9, the two support plates 36 and 37 are arranged in parallel as a set of two, but only one support plate 36 or 37 may be used.

The first cam member 38 is a cylindrical metal member. The first cam member 38 is externally fitted and fixed in a state in which the first cam member 38 is not rotatable relative to the first shaft 24. A first arc-shaped groove portion 38b and a second arc-shaped groove portion 38c can be formed on an outer peripheral surface 38a of the first cam member 38. The arc-shaped groove portions 38b and 38c are arranged in the axial direction of the first shaft 24. The first arc-shaped groove portion 38b and the second arc-shaped groove portion 38c can be misaligned by, for example, 100 degrees with respect to the circumferential direction of the outer peripheral surface 38a. The 100 degrees is an angular difference between the 0-degree position and the first angular position (100-degree position). More specifically, the first arc-shaped groove portion 38b may be misaligned by 100 degrees in the opening direction (direction from 0 degrees to 360 degrees) with respect to the second arc-shaped groove portion 38c. In other words, the second arc-shaped groove portion 38c can be misaligned by 100 degrees in the closing direction (direction from 360 degrees to 0 degrees) with respect to the first arc-shaped groove portion 38b.

The first arc-shaped groove portion 38b is located at a position at which a first end portion 42a of the first slider 42 can face the first arc-shaped groove portion 38b in the axial direction of the first shaft 24. The second arc-shaped groove portion 38c is located at a position at which a first end portion 43a of the second slider 43 can face the second arc-shaped groove portion 38c in the axial direction of the first shaft 24. The first end portions 42a and 43a of the sliders 42 and 43 can be inserted into the arc-shaped groove portions 38b and 38c, respectively. The inserted first end portions 42a and 43a are movable relative to the arc-shaped groove portions 38b and 38c in the circumferential direction. The second arc-shaped groove portion 38c has a locking part 38cl which is a wall surface on one side in the circumferential direction of the second arc-shaped groove portion 38c. The locking part 38cl is able to lock the first end portion 43a of the second slider 43 in a case in which the second shaft 26 is rotated from the 0-degree position to the first angular position (100-degree position) in the opening direction (see FIG. 12).

The second cam member 39 is a cylindrical metal member. The second cam member 39 is externally fitted and fixed to the second shaft 26 in a state in which the second cam member 39 and the second shaft 26 are not rotatable relative to each other. A first recessed portion 39b, a second recessed portion 39c, and a stopper groove portion 39d can be formed on an outer peripheral surface 39a of the second cam member 39. The recessed portions 39b and 39c and the stopper groove portion 39d are arranged in order in the axial direction of the second shaft 26. The recessed portions 39b and 39c may be misaligned by, for example, 180 degrees with respect to the circumferential direction of the outer peripheral surface 39a.

The first recessed portion 39b is located at a position at which the second end portion 42b of the first slider 42 can face the first recessed portion 39b in the axial direction of the second shaft 26. The second recessed portion 39c is located at a position at which the second end portion 43b of the second slider 43 can face the second recessed portion 39c in the axial direction of the second shaft 26. The second end portions 42b and 43b of the sliders 42 and 43 can be fitted into the recessed portions 39b and 39c, respectively. The recessed portions 39b and 39c is able to stop the relative movement of the fitted second end portions 42b and 43b in the circumferential direction. The recessed portions 39b and 39c can have, for example, a substantially arc-shaped cross section to which the second end portions 42b and 43b having an arc shape can be fitted and from which the second end portions 42b and 43b can be removed.

The stopper groove portion 39d is located at a position facing the stopper portion 40c of the stopper cam member 40 in the axial direction of the second shaft 26. The stopper portion 40c is inserted into the stopper groove portion 39d and is movable relative to the stopper groove portion 39d in the circumferential direction. The stopper groove portion 39d has stopper surfaces 39d1 and 39d2 which are wall surfaces on one side and the other side of the stopper groove portion 39d in the circumferential direction. The stopper surface (open stopper surface) 39d1 abuts against the stopper portion 40c when the second shaft 26 is rotated from the first angular position (100-degree position) to the second angular position (280-degree position) in the opening direction. The stopper surface (close stopper surface) 39d2 abuts against the stopper portion 40c when the second shaft 26 is rotated from the second angular position (280-degree position) to the first angular position (100-degree position) in the closing direction.

The stopper cam member 40 can include a support plate 40a, a pair of guide plates 40b and 40b, a stopper portion 40c, and a protruding portion 40d.

The support plate 40a is a substantially flat elliptical metal plate that is bridged over the first shaft 24 and the second shaft 26. The support plate 40a has shaft holes into which the respective shafts 24 and 26 are inserted so as to be rotatable relative to each other at both end portions. Accordingly, the support plate 40a functions as a support member that supports each of the shafts 24 and 26 so as to be rotatable relative to each other while maintaining the inter-shaft distance between the shafts 24 and 26. The support plate 40a is held to sandwich the sliders 42 and 43 between the support plate 40a and the support plate 37. Accordingly, the sliders 42 and 43 are prevented from moving in the axial directions of the shafts 24 and 26.

The pair of guide plates 40b and 40b are protruding pieces that protrude from the support plate 40a toward the support plate 37 side. The pair of guide plates 40b and 40b can be disposed in a line-symmetrical manner with respect to a direction connecting the shaft centers of the shafts 24 and 26 (hereinafter, also referred to as an “inter-shaft direction D”). The pair of guide plates 40b and 40b is able to guide the sliders 42 and 43 to be slidable along the inter-shaft direction D between the facing surfaces thereof.

A protrusion 40b1 is formed on an end surface of each guide plate 40b on the support plate 37 side. The protrusion 40b1 is fitted into a groove formed in the outer peripheral edge surface of the support plate 37. As a result, each guide plate 40b is prevented from being misaligned in the inter-shaft direction D. Further, each guide plate 40b is also prevented from being misaligned in a direction orthogonal to the surface normal direction.

The stopper cam member 40 has a thick-walled portion 40e in which a side surface of the support plate 40a on the guide plate 40b side is bulged. The thick-walled portion 40e enters between the shafts 24 and 26. The stopper portion 40c is a protrusion that protrudes from the upper surface of the thick-walled portion 40e. The stopper portion 40c is inserted into the stopper groove portion 39d of the second cam member 39. When the second cam member 39 is rotated together with the second shaft 26, the stopper portion 40c is able to stop further rotation of the second shaft 26 by abutting against the stopper surfaces 39d1 and 39d2 of the stopper groove portion 39d.

The protruding portion 40d protrudes from a side surface of the support plate 40a opposite to the thick-walled portion 40e side and is disposed between the torque generation units 33 and 35. A female screw that tightens the screw for fastening the hinge chassis 28 is formed in the protruding portion 40d.

The first slider 42 and the second slider 43 are metal members having a substantially flat elliptical cross-sectional shape. The first slider 42 has the first end portion 42a facing the first shaft 24 side and the second end portion 42b facing the second shaft 26 side. The second slider 43 has the first end portion 43a facing the first shaft 24 side and the second end portion 43b facing the second shaft 26 side. The end portions 42a, 42b, 43a, and 43b can have an arc shape.

The sliders 42 and 43 are each independently slidable along the inter-shaft direction D. The first slider 42 is disposed at a position at which the first slider 42 can face the first arc-shaped groove portion 38b of the first cam member 38 and the first recessed portion 39b of the second cam member 39 with respect to the axial directions of the shafts 24 and 26. The second slider 43 is disposed at a position at which the second slider 43 can face the second arc-shaped groove portion 38c of the first cam member 38 and the second recessed portion 39c of the second cam member 39.

Rectangular hollow portions 42c and 43c extending in the inter-shaft direction D are formed at the centers of the sliders 42 and 43, respectively. A guide rod 46 extending along the axial direction between the shafts 24 and 26 is inserted into the hollow portions 42c and 43c. One end portion of the guide rod 46 in the longitudinal direction is fitted and supported by the support plates 36 and 37, and the other end portion of the guide rod 46 is fitted and supported by the thick-walled portion 40e. The width (height) of the guide rod 46 in the inter-shaft direction D is shorter than the width (height) of the hollow portions 42c and 43c in the inter-shaft direction D. The outer peripheral side surfaces of the sliders 42 and 43 are guided by the pair of guide plates 40b and 40b, and further the hollow portions 42c and 43c are guided by the guide rod 46. Accordingly, the sliders 42 and 43 can smoothly slide along the inter-shaft direction D.

Next, a rotational operation of the chassis 11 and 12 by the hinge device 14 will be described.

The operation and action of the hinge device 14 when the second chassis 12 at the 0-degree position is opened to the 360-degree position will be described. This operation is performed, for example, by a user gripping the upper end portion (end portion on a side opposite to the edge portion 12c side) of the second chassis 12 and applying an external force in the opening direction.

An operation from the 0-degree position to the first angular position (100-degree position) will be described.

In this case, the first end portion 42a of the first slider 42 is disposed at a position at which the first end portion 42a can slide on the outer peripheral surface 38a of the first cam member 38 (see FIG. 10A). The first end portion 43a of the second slider 43 is disposed at a position at which the second slider 43 is movable relative to the second arc-shaped groove portion 38c of the first cam member 38 in the circumferential direction (see FIG. 10B). Therefore, the rotation of the first shaft 24 is allowed. On the other hand, the second end portion 42b of the first slider 42 is fitted to the first recessed portion 39b of the second cam member 39 (see FIG. 10A). That is, the first slider 42 is in a state in which the first slider 42 cannot slide in the inter-shaft direction D. Therefore, the rotation of the second shaft 26 is stopped.

Between the 0-degree position and the first angular position, the stopper portion 40c of the stopper cam member 40 abuts against the stopper surface 39d2 of the second cam member 39 (see FIG. 10C). The stopper portion 40c is located at a position at which the stopper portion 40c is movable relative to the stopper groove portion 39d in the opening direction.

Therefore, as illustrated in FIGS. 10 to 12, between the 0-degree position and the first angular position, the first shaft 24 is a rotation shaft and the second shaft 26 is locked. Therefore, the second chassis 12 rotates with the first shaft 24 as a rotation shaft. In this case, the hinge chassis 28 also rotates with the first shaft 24 as a rotation shaft (see FIGS. 2 and 3).

Accordingly, at the first angular position at which using in the laptop mode is expected, the shaft center of the second shaft 26 is disposed below the shaft center of the first shaft 24 in the thickness direction (up-down direction) of the first chassis 11 (see FIGS. 3 and 12). That is, the edge portion 12c of the second chassis 12 is disposed below the upper surface 11a of the first chassis 11 in the up-down direction (drop down). As a result, the electronic apparatus 10 is able to hide a part or all of the lower bezel 11d of the display 20 behind the first chassis 11, and the appearance quality is improved. In this case, the edge portion 12c of the second chassis 12 does not come into contact with the placement surface 19 (see FIG. 3). In other words, the electronic apparatus 10 is able to employ a rubber foot 18 that secures a height at which the edge portion 12c does not come into contact with the placement surface 19 at the first angular position illustrated in FIG. 3.

By the way, in the first folded form (0-degree position), the stopper portion 40c is at a position at which the stopper portion 40c cannot move relative to the stopper groove portion 39d in the closing direction (see FIG. 10C). That is, in the first folded form of the electronic apparatus 10, the first slider 42 is fitted into the first recessed portion 39b, and at the same time, the stopper portion 40c is locked by the stopper surface 39d2. Accordingly, the rotation of the second chassis 12 in the closing direction is more reliably stopped. Therefore, in the first folded form in which it is expected that the electronic apparatus 10 will be carried around, the positional relationship between the chassis 11 and 12 is more firmly maintained. Therefore, in the electronic apparatus 10, rattling between the chassis 11 and 12 is suppressed during carrying or the like.

An operation from the first angular position (100-degree position) to the 120-degree position will be described.

At the first angular position illustrated in FIG. 12, the first end portion 42a of the first slider 42 is disposed at a position at which the first end portion 42a can be inserted into the first arc-shaped groove portion 38b of the first cam member 38 (see FIG. 12A). That is, the first slider 42 is in a state in which it can slide in the inter-shaft direction D. On the other hand, the first end portion 43a of the second slider 43 is locked to the locking part 38cl of the second arc-shaped groove portion 38c (see FIG. 12B). The second end portion 43b is disposed at a position at which the second end portion 43b can slide on the outer peripheral surface 39a of the second cam member 39. That is, the second slider 43 is in a state in which the second slider 43 cannot slide in the inter-shaft direction D. Therefore, the rotation of the first shaft 24 is stopped. In other words, any further rotation of the second chassis 12 (hinge chassis 28) about the first shaft 24 is stopped.

When the second chassis 12 receives a rotational force toward the 120-degree position from the first angular position, the second shaft 26 receives the rotational force. In this case, the first recessed portion 39b of the second cam member 39 presses the second end portion 42b of the first slider 42 with the edge wall thereof. Accordingly, the first slider 42 slides to the first shaft 24 side. The first end portion 42a is inserted into the first arc-shaped groove portion 38b (see FIG. 13A). In this case, the second end portion 42b of the first slider 42 is disposed at a position at which the second cam member 39 can slide on the outer peripheral surface 39a. Therefore, the rotation of the second shaft 26 is allowed. The stopper portion 40c moves relative to the stopper groove portion 39d between the first angular position and the 120-degree position.

Therefore, as illustrated in FIGS. 12 and 13, between the first angular position and the 120-degree position, the second shaft 26 is a rotation shaft and the first shaft 24 is locked. Therefore, the second chassis 12 rotates with the second shaft 26 as a rotation shaft. In this case, the hinge chassis 28 does not rotate (see FIGS. 3 and 4).

Accordingly, even at the 120-degree position at which using in the laptop mode is expected, the height relationship between the second shaft 26 and the first shaft 24 is maintained at the first angular position. That is, the shaft center of the second shaft 26 is below the shaft center of the first shaft 24 (see FIGS. 4 and 13). In general, the electronic apparatus 10 is most suitable for the angle range between the 100-degree position and the 120-degree position in the laptop mode. In the electronic apparatus 10, in this angle range, a state in which the edge portion 12c is below the upper surface 11a is maintained. That is, the electronic apparatus 10 maintains the drop-down state at least within this angle range, and it is possible to obtain high appearance. In addition, between the first angular position and the 120-degree position, the edge portion 12c of the second chassis 12 does not move in the up-down direction (see FIGS. 3, 4, 12 and 13). Therefore, the contact of the edge portion 12c with the placement surface 19 is suppressed within the above-described angle range in which the electronic apparatus 10 is expected to be used in the laptop mode. As a result, the electronic apparatus 10 is prevented from rattling on the placement surface 19, and the second chassis 12 is prevented from being damaged on the placement surface 19.

An operation from the 120-degree position to the second angular position (280-degree position) will be described.

The operation in this case is the same as the operation from the first angular position to the 120-degree position (see FIGS. 13 to 15). That is, the first end portion 43a of the second slider 43 is locked by the locking part 38cl of the first cam member 38. Therefore, the rotation of the first shaft 24 is stopped. On the other hand, the second end portions 42b and 43b of the sliders 42 and 43 are disposed at positions at which the outer peripheral surface 39a of the second cam member 39 can slide. Therefore, the rotation of the second shaft 26 is allowed. The stopper portion 40c moves relative to the stopper groove portion 39d between the 120-degree position and the second angular position.

An operation from the second angular position (280-degree position) to the 360-degree position will be described.

At the second angular position illustrated in FIG. 15, the second recessed portion 39c of the second cam member 39 is disposed at a position facing the second end portion 43b of the second slider 43 (see FIG. 15B). That is, the second slider 43 is in a state of being slidable in the inter-shaft direction D. On the other hand, the first end portion 42a of the first slider 42 is disposed at a position at which the first end portion 42a is movable relative to the arc-shaped groove portion 38b of the first cam member 38 (see FIG. 15A). The second end portion 42b is disposed at a position at which the second end portion 42b can slide on the outer peripheral surface 39a of the second cam member 39.

When the second chassis 12 receives a rotational force from the second angular position to the 360-degree position, the first shaft 24 receives the rotational force. In this case, the locking part 38cl of the first cam member 38 presses the first end portion 43a of the second slider 43. As a result, the second slider 43 slides to the second shaft 26 side. The second end portion 43b is fitted into the second recessed portion 39c (see FIG. 16B). In this case, the first end portion 43a of the second slider 43 is separated from the second arc-shaped groove portion 38c and is disposed at a position at which the first cam member 38 can slide on the outer peripheral surface 38a. Therefore, the rotation of the second shaft 26 is stopped, and the rotation of the first shaft 24 is allowed.

At the second angular position, the stopper portion 40c abuts against the stopper surface 39d1 of the stopper groove portion 39d. Therefore, further rotation of the second shaft 26 is more reliably stopped. Therefore, when the second slider 43 is rotated in the opening direction from the second angular position, the second slider 43 slides more smoothly.

Accordingly, as illustrated in FIGS. 15 to 17, between the second angular position and the 360-degree position, the first shaft 24 is a rotation shaft again, and the second shaft 26 is locked. Therefore, the second chassis 12 rotates with the first shaft 24 as a rotation shaft. In this case, the hinge chassis 28 is also rotated with the first shaft 24 as a rotation shaft (see FIGS. 6 and 7). Accordingly, the electronic apparatus 10 can be set in the second folded form (360-degree position) and can be used in the tablet mode.

The stopper portion 40c abuts against the stopper surface 39d1 between the second angular position and the 360-degree position. That is, the stopper portion 40c is located at a position at which the stopper portion 40c is movable relative to the stopper groove portion 39d in the closing direction.

On the other hand, in the second folded form (360-degree position), the stopper portion 40c is at a position at which the stopper portion 40c cannot move relative to the stopper groove portion 39d in the opening direction. That is, in the second folded form of the electronic apparatus 10, the second slider 43 is fitted into the second recessed portion 39c, and at the same time, the stopper portion 40c is locked by the stopper surface 39d1. In the electronic apparatus 10, the rotation of the second chassis 12 in the opening direction in the second folded form is more reliably stopped. Therefore, in the second folded form in which the electronic apparatus 10 is expected to be used in the tablet mode, the positional relationship between the chassis 11 and 12 is more firmly maintained. In the electronic apparatus 10, for example, rattling when a touch operation is performed on the display 20 and shaking of the second chassis 12 are suppressed.

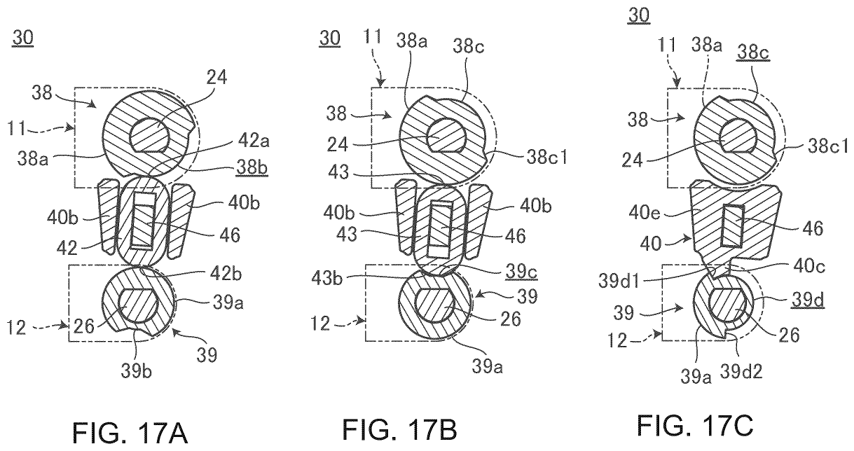

The operation of the hinge device 14 when the second chassis 12 at the 360-degree position is closed to the 0-degree position is an operation opposite to the opening operation described above, and thus, the detailed description thereof will be omitted. That is, the hinge device 14 operates as illustrated in FIGS. 17 to 10.

As described above, the electronic apparatus 10 and the hinge device 14 can include the first slider 42 that is slidable between the first shaft 24 and the second shaft 26 and the second slider 43 that is slidable between the first shaft 24 and the second shaft 26. The electronic apparatus 10 and the hinge device 14 can further include the first cam member 38 that is fixed to the first shaft 24 and is provided with the locking part 38cl to which the first end portion 43a of the second slider 43 is fittable on the outer peripheral surface 38a, and the second cam member 39 that is fixed to the second shaft 26 and is provided with the first recessed portion 39b into which the second end portion 42b of the first slider 42 can be fitted and the second recessed portion 39c into which the second end portion 43b of the second slider 43 can be fitted, on the outer peripheral surface 39a.

Accordingly, the hinge device 14 is able to select the shafts 24 and 26 that act as the rotation shaft at a desired rotation timing by the stop action of the cam members 38 and 39 by the two sliders 42 and 43. Therefore, the electronic apparatus 10 is able to easily switch between the shafts 24 and 26 as a rotation shaft at the first angular position on the closing side from the 120-degree position expected as most preferred for using in, for example, the laptop mode. Therefore, when the electronic apparatus 10 is used in the laptop mode, it is possible to prevent the second chassis 12 from coming into contact with the placement surface 19, which may result in rattling or damage. In addition, when the electronic apparatus 10 is used in the laptop mode, the second chassis 12 is prevented from coming into contact with the placement surface 19 and the first chassis 11 is prevented from being lifted. Furthermore, since the electronic apparatus 10 has the two chassis 11 and 12 disposed substantially flat when viewed from the side at a 180-degree position, the appearance quality is further improved. Moreover, when the electronic apparatus 10 is used in the laptop mode, the edge portion 12c of the second chassis 12 is disposed behind and below the first chassis 11, and thus it is possible to obtain an even higher appearance quality.

In particular, the hinge device 14 includes two sliders 42 and 43 that slide between the shafts 24 and 26, and two cam members 38 ad 39 which the sliders 42 and 43 are fitted to and slide on. The hinge device 14 is configured to selectively switch between the rotation shaft at the first angular position and the second angular position. In other words, the hinge device 14 realizes the switching of the rotation shaft twice without requiring a member that moves in the axial directions of the shafts 24 and 26. Therefore, the hinge device 14 is able to simplify the configuration and is also able to suppress the axial width of the entire device, and thus it is easy to reduce the size. Further, since the hinge device 14 does not have a member that moves in the axial directions of the shafts 24 and 26, it is possible to suppress the hindrance to the rotation of each of the shafts 24 and 26, and it is possible to perform a smoother rotational operation.

The hinge device 14 can include the stopper surface 39d1 that is formed on the outer peripheral surface 39a of the second cam member 39 and faces the circumferential direction thereof, and the stopper portion 40c that abuts against the stopper surface 39d1. For example, the stopper portion 40c can be configured to abut against the stopper surface 39d1 at the second angular position (280 degrees) in a case of the opening operation (see FIG. 15C). In this case, the sliding of the second slider 43 is smoother, and the switching from the second shaft 26 to the first shaft 24 is smoother.

The hinge device 14 can further include the stopper surface 39d2 that is formed on the outer peripheral surface 39a of the second cam member 39 and that is provided on a side opposite to the stopper surface 39d1 facing the circumferential direction thereof. For example, the stopper portion 40c can be configured to abut against the stopper surface 39d2 at the first angular position (100 degrees) in a case of the closing operation (see FIG. 12C). In this case, the sliding of the first slider 42 is smoother, and the switching from the second shaft 26 to the first shaft 24 is smoother.

The present invention is not limited to the above-described embodiments, and it goes without saying that the present invention can be freely modified without departing from the gist of the present invention.

### DESCRIPTION OF SYMBOLS

10 electronic apparatus
11 first chassis
12 second chassis
14L, 14R hinge device
16 keyboard
20 display
24 first shaft
26 second shaft
28 hinge chassis
30 rotation shaft selection mechanism portion
36, 37, 40a support plate
38 first cam member
38a, 39a outer peripheral surface
38b first arc-shaped groove portion
38c second arc-shaped groove portion
39 second cam member
39b first recessed portion
39c second recessed portion
39d1, 39d2 stopper surface
40 stopper cam member
40c stopper portion
42 first slider
43 second slider

What is claimed is:

1. An electronic apparatus comprising:
a first chassis having a first surface and a second surface;
a second chassis having a first surface and a second surface and adjacent to the first chassis; and
a hinge device configured to connect the first chassis and the second chassis to be rotatable from a first folded form in which first surfaces of the first chassis and the second chassis face each other to a second folded form in which second surfaces of the first chassis and the second chassis face each other, by connecting edge portions of the first chassis and the second chassis adjacent to each other to be rotatable relative to each other,
wherein the hinge device includes
a first shaft fixed relative to the first chassis,
a second shaft fixed relative to the second chassis,
a support member configured to support the first shaft and the second shaft so as to be rotatable relative to each other with axial directions parallel to each other,
a first slider having a first end portion facing a first shaft side and a second end portion facing a second shaft side, and configured to be slidable between the first shaft and the second shaft,
a second slider having a first end portion facing the first shaft side and a second end portion facing the second shaft side and configured to be slidable between the first shaft and the second shaft,
a first cam member fixed to the first shaft and having an outer peripheral surface provided with a locking part to which the first end portion of the second slider is fittable, and
a second cam member fixed to the second shaft and having an outer peripheral surface provided with a first recessed portion into which the second end portion of the first slider is fittable and a second recessed portion into which the second end portion of the second slider is fittable.

2. The electronic apparatus according to claim 1,
wherein the first cam member has
a first arc-shaped groove portion that extends in a circumferential direction of the outer peripheral surface, with the first end portion of the first slider movable relative to the first arc-shaped groove portion along an extending direction, and
a second arc-shaped groove portion that extends in the circumferential direction of the outer peripheral surface, with the first end portion of the second slider movable relative to the second arc-shaped groove portion along an extending direction, and of which a wall surface on one end side in the extending direction is the locking part.

3. The electronic apparatus according to claim 2,
wherein the first chassis and the second chassis sequentially pass through a first angular position and a second angular position when rotating from the first folded form to the second folded form,
in the hinge device,
when the first chassis and the second chassis are between the first folded form and the first angular position, rotation of the first shaft is allowed by the first end portion of the first slider being disposed at a position to be slidable on the outer peripheral surface of the first cam member and the first end portion of the second slider being disposed at a position to be movable relative to the second arc-shaped groove portion, while rotation of the second shaft is stopped by the second end portion of the first slider being fitted into the first recessed portion,
when the first chassis and the second chassis are between the first angular position and the second angular position, the rotation of the first shaft is stopped by the first end portion of the second slider being locked by the locking part, while the rotation of the second shaft is allowed by the second end portion of the first slider and the second end portion of the second slider being both disposed at positions to be slidable on the outer peripheral surface of the second cam member, and
when the first chassis and the second chassis are between the first angular position and the second folded form, the rotation of the first shaft is allowed by the first end portion of the first slider being disposed at a position to be movable relative to the first arc-shaped groove portion and the first end portion of the second slider being disposed at a position to be slidable on the outer peripheral surface of the first cam member, while the rotation of the second shaft is stopped by the second end portion of the second slider being fitted into the second recessed portion.

4. The electronic apparatus according to claim 3,
wherein when the first chassis and the second chassis are in the first folded form, the first shaft and the second shaft are disposed with an axis center of the second shaft above an axis center of the first shaft, with respect to a thickness direction of the first chassis, and
when the first chassis and the second chassis are in the first angular position, the first chassis and the second chassis are disposed with the axis center of the second shaft lower than the axis center of the first shaft, with respect to the thickness direction of the first chassis.

5. The electronic apparatus according to claim 4,
wherein the first chassis is mounted with a keyboard facing the first surface, and
the second chassis is mounted with a display facing the first surface.

6. The electronic apparatus according to claim 4,
wherein the second cam member has a stopper surface facing a circumferential direction on the outer peripheral surface, and
the hinge device further includes a stopper portion that abuts against the stopper surface.

7. A hinge device that connects a first chassis and a second chassis of an electronic apparatus to be rotatable, the hinge device comprising:
a first shaft fixed relative to the first chassis;
a second shaft fixed relative to the second chassis;
a support member configured to support the first shaft and the second shaft so as to be rotatable relative to each other with axial directions parallel to each other;
a first slider having a first end portion facing a first shaft side and a second end portion facing a second shaft side, and configured to be slidable between the first shaft and the second shaft;
a second slider having a first end portion facing the first shaft side and a second end portion facing the second shaft side and configured to be slidable between the first shaft and the second shaft;
a first cam member fixed to the first shaft and having an outer peripheral surface provided with a locking part to which the first end portion of the second slider is fittable; and
a second cam member fixed to the second shaft and having an outer peripheral surface provided with a first recessed portion into which the second end portion of the first slider is fittable and a second recessed portion into which the second end portion of the second slider is fittable.

8. The hinge device according to claim 7,
wherein the first cam member has
a first arc-shaped groove portion that extends in a circumferential direction of the outer peripheral surface, with the first end portion of the first slider movable relative to the first arc-shaped groove portion along an extending direction, and
a second arc-shaped groove portion that extends in the circumferential direction of the outer peripheral surface, with the first end portion of the second slider is movable relative to the second arc-shaped groove portion along an extending direction, and of which a wall surface on one end side in the extending direction is the locking part.

9. The hinge device according to claim 8,
wherein a hinge device connects the first chassis and the second chassis to be rotatable from a first folded form in which first surfaces of the first chassis and the second chassis face each other to a second folded form in which second surfaces of the first chassis and the second chassis face each other, by connecting edge portions of the first chassis and the second chassis adjacent to each other to be rotatable relative to each other,
the first chassis and the second chassis sequentially pass through a first angular position and a second angular position when rotated from the first folded form to the second folded form,
in the hinge device,
when the first chassis and the second chassis are between the first folded form and the first angular position, rotation of the first shaft is allowed by the first end portion of the first slider being disposed at a position to be slidable on the outer peripheral surface of the first cam member and the first end portion of the second slider being disposed at a position to be movable relative to the second arc-shaped groove portion, while rotation of the second shaft is stopped by the second end portion of the first slider being fitted into the first recessed portion,
when the first chassis and the second chassis are between the first angular position and the second angular position, the rotation of the first shaft is stopped by the first end portion of the second slider being locked by the locking part, while the rotation of the second shaft is allowed by the second end portion of the first slider and the second end portion of the second slider being both disposed at positions to be slidable on the outer peripheral surface of the second cam member, and
when the first chassis and the second chassis are between the first angular position and the second folded form, the rotation of the first shaft is allowed by the first end portion of the first slider being disposed at a position to be movable relative to the first arc-shaped groove portion and the first end portion of the second slider being disposed at a position to be slidable on the outer peripheral surface of the first cam member, while the rotation of the second shaft is stopped by the second end portion of the second slider being fitted into the second recessed portion.
